(19) United States
(12) Patent Application Publication
(10) Pub. No.: US 2019/0168565 A1
(43) Pub. Date: Jun. 6, 2019

(54) PNEUMATIC ANTI-ROLL SYSTEM

(71) Applicant: STEMCO PRODUCTS, INC., Charlotte, NC (US)

(72) Inventors: Paul DOLAN, Clio, MI (US); James Richard NEAL, Canton, MI (US); Thor David SABGASH, Millington, MI (US); Bradley Edward HADDIX, Millington, MI (US); Christian Eugene LOUIS, Millington, MI (US); Jason Douglas TRATO, Millington, MI (US); Jeffrey Alan GEIST, Brighton, MI (US); Donald A. RAITZER, Farmington, MI (US)

(21) Appl. No.: 16/325,151

(22) PCT Filed: Aug. 21, 2017
(86) PCT No.: PCT/US2017/047734

§ 371 Date: Feb. 12, 2019

Related U.S. Application Data
(60) Provisional application No. 62/378,081, filed on Aug. 22, 2016.

(51) Int. Cl. B60G 21/073; B60G 11/27; B60G 17/056; B60G 21/02; B60G 17/015; B60G 17/016

(52) U.S. Cl. CPC B60G 21/073; B60G 11/27; B60G 17/0565; B60G 21/026; B60G 17/0155; B60G 2300/042; B60G 2202/152; B60G 2500/202; B60G 2800/012; B60G 2204/82; B60G 2204/8304; B60G 17/0162

(57) ABSTRACT

Technology is provided for a pneumatic anti-roll system for use on a vehicle suspension. The pneumatic anti-roll system includes left and right side air springs connectable between a chassis of the vehicle and an axle of the vehicle suspension. Left and right side height control valves are mounted to the chassis and left and right side linkages connect between the left and right side height control valves and corresponding left and right end portions of the axle. Left and right side control air lines connect between the left and right side height control valves and corresponding left and right side air springs, respectively.

### CROSS-REFERENCE TO RELATED APPLICATIONS

This application claims the benefit of and priority to U.S. Patent Application No. 62/378,081, filed Aug. 22, 2016, the disclosure of which is incorporated herein by reference in its entirety.

### TECHNICAL FIELD

This patent application is directed to vehicle suspension and, more specifically, to anti-roll systems.

### BACKGROUND

A typical mechanical anti-roll bar or sway bar is a torsion spring connected between the left and right sides of a vehicle's suspension. The anti-roll bar acts independently of the main suspension springs. As one side of the suspension moves, the anti-roll bar tends to force the opposite side of the suspension, via the torsion spring, to move in the same direction. Thus, the anti-roll bar increases the vehicle suspension's roll stiffness, which increases the vehicle's resistance to rolling in turns.

### BRIEF DESCRIPTION OF THE DRAWINGS

Embodiments of the pneumatic anti-roll system introduced herein may be better understood by referring to the following Detailed Description in conjunction with the accompanying drawings, in which like reference numerals indicate identical or functionally similar elements:

FIG. 1 is a side view in elevation of a representative semi-trailer truck.

FIG. 2 is a schematic representation of a conventional air ride suspension height control system.

FIG. 3 is a schematic representation of a pneumatic anti-roll system according to a representative embodiment.

FIG. 4 is an enlarged view of a height control valve shown in FIG. 3.

FIG. 5 is a rear view of the semi-trailer shown in FIG. 1.

FIG. 6 is an isometric view of a double wishbone independent trailer suspension.

FIG. 7 is an end view of the suspension shown in FIG. 6.

FIG. 8 is a schematic representation of a pneumatic anti-roll system according to another representative embodiment.

The headings provided herein are for convenience only and do not necessarily affect the scope or meaning of the claimed embodiments. Further, the drawings have not necessarily been drawn to scale. For example, the dimensions of some of the elements in the figures may be expanded or reduced to help improve the understanding of the embodiments. Moreover, while the disclosed technology is amenable to various modifications and alternative forms, specific embodiments have been shown by way of example in the drawings and are described in detail below. The intention, however, is not to limit the embodiments described. On the contrary, the embodiments are intended to cover all modifications, equivalents, and alternatives falling within the scope of the embodiments as defined by the appended claims.

### DETAILED DESCRIPTION

### Overview

A pneumatic anti-roll system for use on a vehicle suspension is disclosed. The pneumatic anti-roll system reduces the impact of lateral load transfer on a vehicle, such as a trailer, improving vehicle handling and control and decreasing tire wear under normal driving conditions. In heavy trucks and trailers an air ride suspension uses air springs as the main springs of the suspension. The disclosed pneumatic anti-roll system leverages these air springs to achieve the desired anti-roll performance but without the need to add the extra weight and complexity of a torsional spring (e.g., anti-roll bar).

In an embodiment, the pneumatic anti-roll system includes left and right side air springs connectable between a chassis of the vehicle and an axle of the vehicle suspension. Left and right side height control valves are mounted to the chassis and left and right side linkages connect between the left and right side height control valves and corresponding left and right end portions of the axle. Left and right side control air lines connect between the left and right side height control valves and the corresponding left and right side air springs, respectively.

### General Description

Various examples of the device and systems introduced above will now be described in further detail. The following description provides specific details for a thorough understanding and enabling description of these examples. One skilled in the relevant art will understand, however, that the techniques discussed herein may be practiced without many of these details. Likewise, one skilled in the relevant art will also understand that the technology can include many other features not described in detail herein. Additionally, some well-known structures or functions may not be shown or described in detail below so as to avoid unnecessarily obscuring the relevant description.

The terminology used below is to be interpreted in its broadest reasonable manner, even though it is being used in conjunction with a detailed description of some specific examples of the embodiments. Indeed, some terms may even be emphasized below; however, any terminology intended to be interpreted in any restricted manner will be overtly and specifically defined as such in this section.

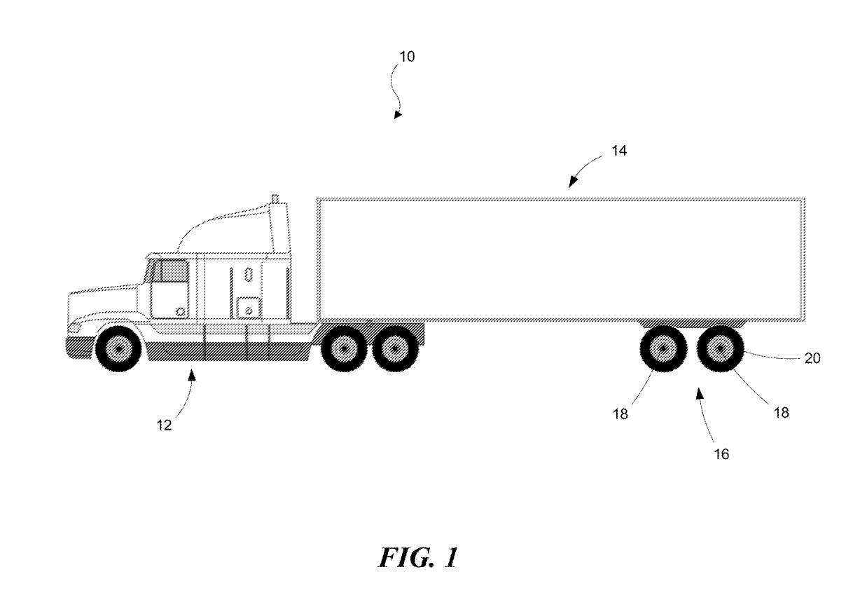

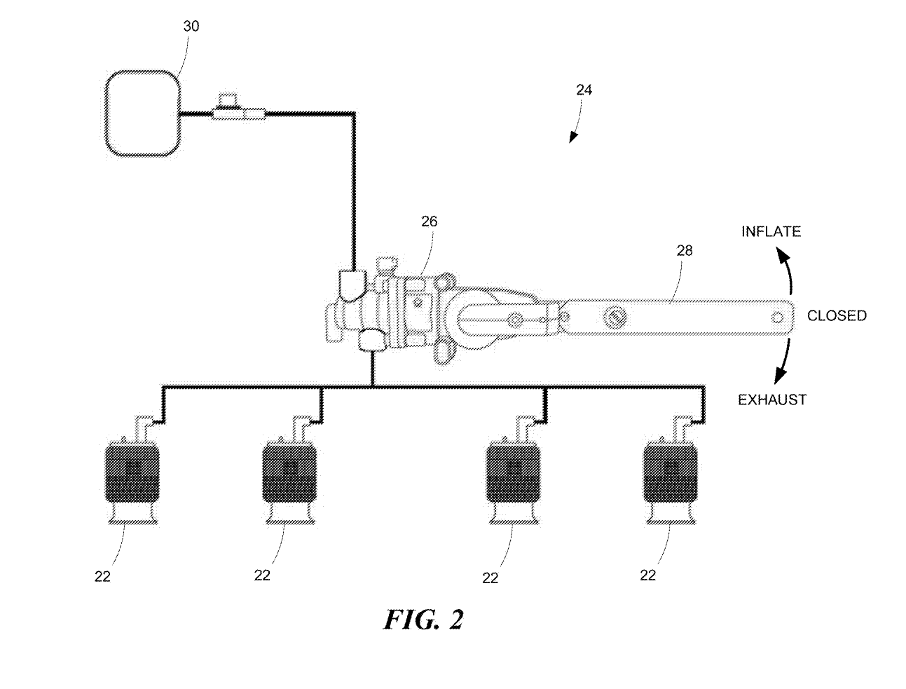

FIG. 1 illustrates a typical semi-trailer truck 10 including a tractor unit 12 connected to a semi-trailer 14. Semi-trailer 14 includes a tandem axle suspension 16 having two axles 18. Typically, each axle 18 includes four wheels 20. With further reference to FIG. 2, a conventional tandem axle suspension 16 includes a pneumatic height control system 24. The pneumatic height control system 24 includes an air supply e.g., air-tank 30, a height control valve 26, and four air springs 22. Each axle 18 is supported on both ends by a corresponding air spring 22.

The height control valve 26 is used to adjust the ride height of the semi-trailer 14 in response to varying loads by changing the air pressure in the air springs 22. The height control valve 26 is mounted on the trailer chassis and the valve lever 28 is connected to the middle of one of the axles 18. When the trailer 14 is at the desired ride height, the lever 28 is approximately level and the valve is “CLOSED”. If additional weight is added to the trailer 14, the air springs 22 will be compressed under the added load consequently reducing the ride height. This will push the lever 28 upward into the “INFLATE” position, opening the valve 26, which adds compressed air from tank 30 to all four of the air springs 22 until the air springs 22 are sufficiently inflated to restore the correct ride height. If the additional weight is removed from the trailer 14, the air springs 22 will extend, consequently increasing the trailer's ride height above the desired height. This will, in turn, move the lever 28 downward into the “EXHAUST” position, which allows compressed air to escape from the air springs 22, thereby reducing the ride height until the desired height is restored.

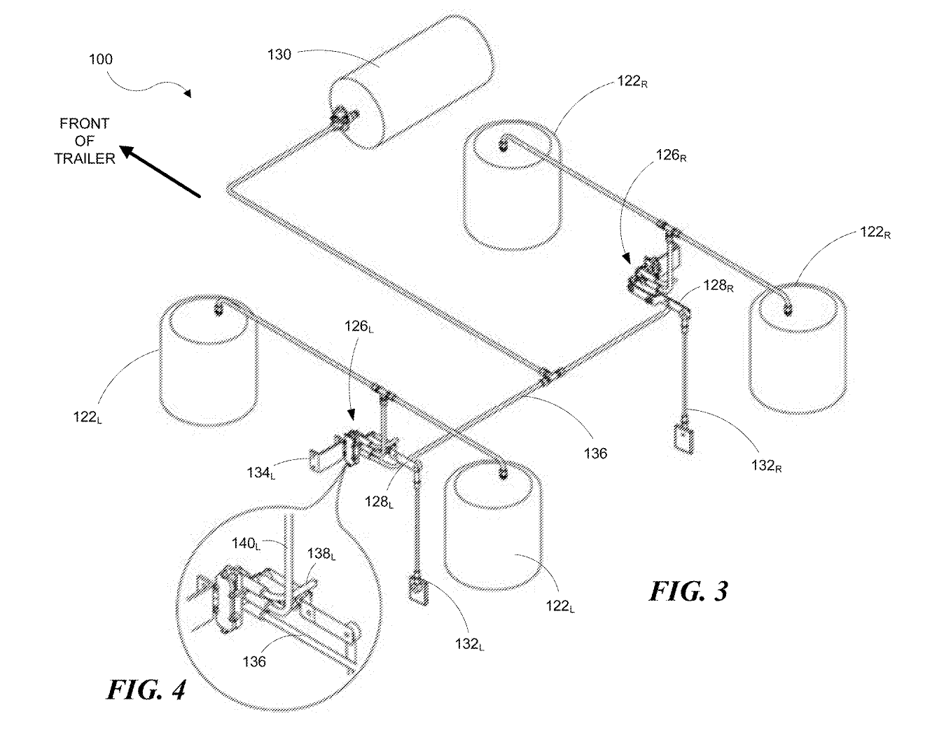

In the pneumatic anti-roll system 100 shown in FIG. 3, multiple height control valves are used to control the ride height of the trailer 14 as well as compensate for asymmetric loading due to cornering. One particular embodiment uses a pair of valves 126_{L} and 126_{R}, for the left and right sides of the trailer 14. By separating the pressure control of the left 122_{L} and right 122_{R} side air springs it is possible to adjust for asymmetric loading on the trailer due to weight transfer under cornering or due to uneven loading of cargo in the trailer.

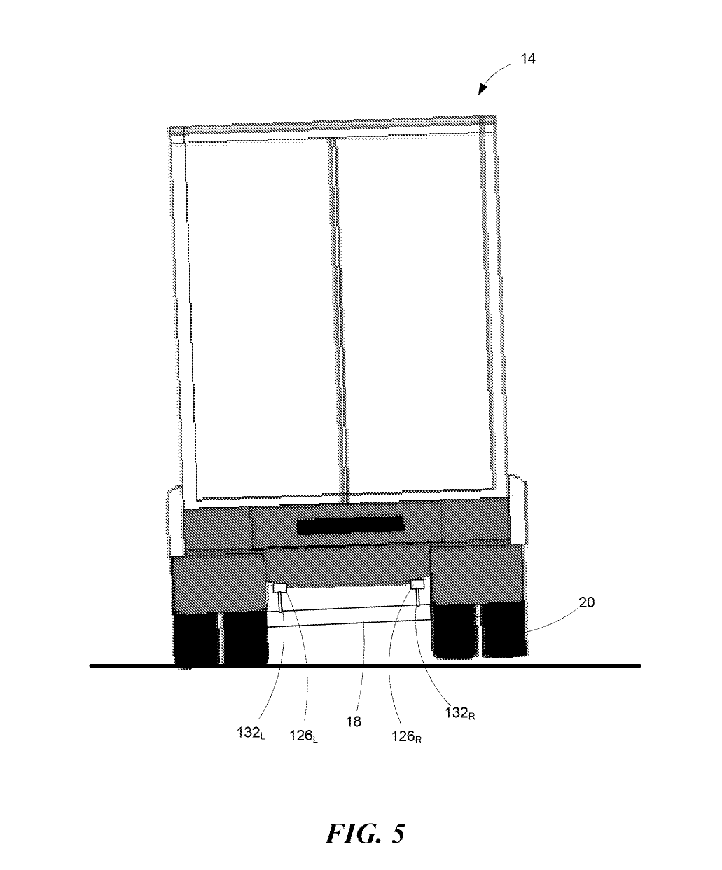

The pneumatic anti-roll system 100 includes an air supply e.g., air-tank 130 connected to the left and right side height control valves 126_{L} and 126_{R} via supply line 136. As shown in FIG. 4, each height control valve 126_{L} and 126_{R} is connected to a control line to selectively supply air to the air springs from air-tank 130 and vent pressure from the air springs through an exhaust. For example, height control valve 126_{L} is operative to supply air pressure from air-tank 130 to left side air springs 122_{L} via control line 140_{L} and to vent excess pressure from air springs 122_{L} through exhaust 138_{L}. Returning to FIG. 3, each height control valve 126_{L} and 126_{R} is mounted to the trailer chassis with a corresponding bracket, such as left side valve bracket 134_{L}. Each height control valve 126_{L} and 126_{R} also includes a corresponding valve lever 128_{L} and 128_{R} connected the left and right ends of axle 18 via linkages 132_{L} and 132_{R}, respectively (also see FIG. 5).

When trailer 14 rounds a right-hand corner as shown in FIG. 5, the left end portion of the axle 18 moves upward toward the chassis whereby the outside (i.e., left) air springs 122_{L} are compressed; locally reducing the ride height, thereby opening the height control valve 126_{L} so that extra compressed air will be added to left-side air springs 122_{L}. On the inside of the turn (i.e., right), air springs 122_{R} are extended; locally increasing the ride height, whereby the height control valve 126_{R} exhausts compressed air from the right-side air springs 122_{R}. Adding air to the left-side air springs 122_{L} and exhausting air pressure from right-side air springs 122_{R} acts to push back against the lateral loading created by cornering such that the trailer tends to remain level and body roll of the trailer is reduced.

In situations of asymmetric loadings caused by single wheel loading due to the bumps in the road such as a pothole, the responsiveness of the system is slow enough that it will not impact the pressure in any of the air springs. However, when cornering, the resulting asymmetric loading created by the lateral loading, is held long enough that the system is able to respond.

The pneumatic anti-roll system described herein provides the desired functionality of a mechanical anti-roll bar but without the added weight and complexity because it uses the existing air springs of the main suspension. This also means that as the overall weight of the vehicle is increased the pneumatic system is easily able to adapt to the increased load of extra cargo. This is not possible with a mechanical torsion spring, which would be sized for the gross weight of the vehicle. Thus, it would be over sized for all but the heaviest loading conditions. The pneumatic based system also lends itself to computer control or activation and can be adapted for an active suspension system. In some embodiments, the responsiveness of the system can be tuned by altering the sizing of the valving in order to control fill rates and exhaust rates. In some embodiments, the mechanical valving could be replaced by a computer control system so that this system could become part of an active suspension control system. In another representative embodiment, the system can use height control valves for each wheel. Accordingly, a tandem axle system would have four valves, for example.

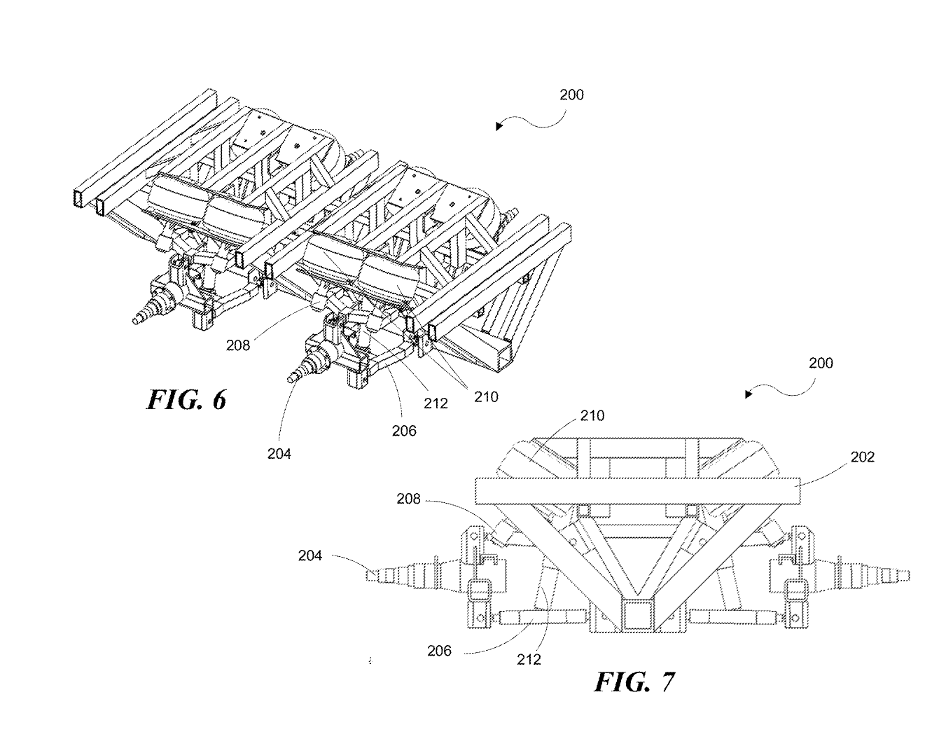

Although the pneumatic anti-roll system has been described with respect to conventional tandem solid axle trailer suspensions, the disclosed technology can be applied to single axle suspensions or suspensions with more than two axles. Furthermore, the pneumatic anti-roll system can be applied to other suspension system configurations incorporating air springs. For example, the pneumatic anti-roll system can be applied to the double wishbone independent trailer suspension 200 shown in FIGS. 6 and 7. The double wishbone suspension 200 includes a sub-frame 202 supporting multiple wheel spindles 204. Each spindle 204 is suspended on upper 208 and lower 206 wishbone control arms. Multiple air springs 210 are positioned between the upper control arm 208 and the sub-frame 202 to support the weight of the trailer. A shock absorber 212 (e.g., damper) is connected between the lower control arm 206 and the sub-frame 202 to help control movement of the suspension. In at least one embodiment, the height control valves of the pneumatic anti-roll system are mounted to the sub-frame 202 and linkages connect the valve lever to the upper or lower control arms to actuate the height control valve. The double wishbone suspension is further described in co-pending U.S. Patent Application No. 62/378,077 (Attorney Docket No. 89143-8080.US00), filed Aug. 22, 2016, entitled DOUBLE WISHBONE INDEPENDENT TRAILER SUSPENSION, the disclosure of which is incorporated herein by reference in its entirety.

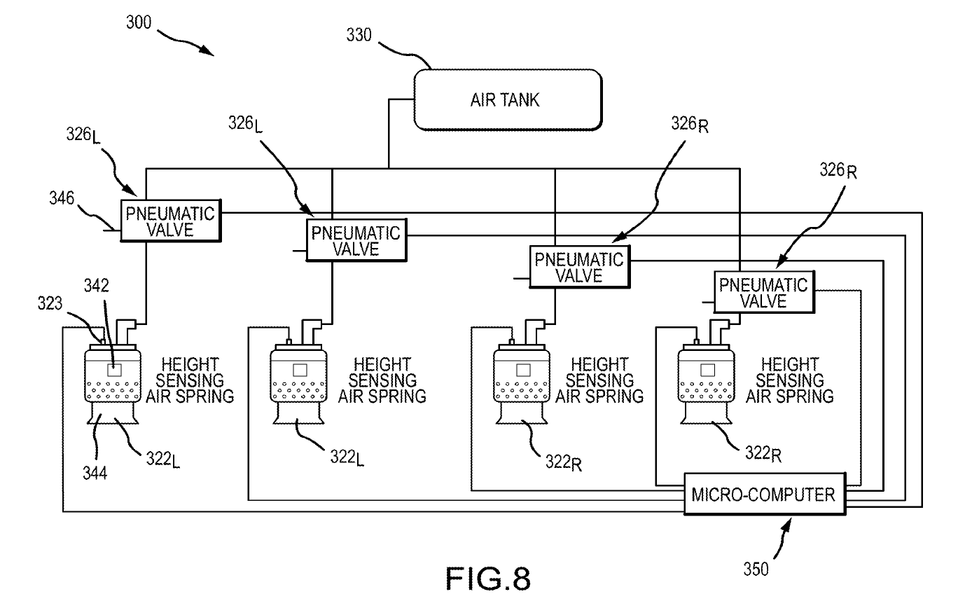

FIG. 8 illustrates a pneumatic anti-roll system 300 according to another representative embodiment. The pneumatic anti-roll system 300 includes a set of electronic micro-computer controlled pneumatic valves 326. Built into each air spring 322 is a non-contact height sensor 323, a device that is able to measure the distance between the upper 342 and lower 344 mount plates of the air spring 322. The height sensors 323 output electrical signals to a small micro-computer 350 which uses these signals to determine the ride height of the vehicle at each wheel. If the micro-computer 350 senses that a wheel end is no longer at a predetermined nominal ride height it is then able to adjust the air pressure in a given air spring by operating the corresponding valve 326 to either supply more air pressure from tank 330 to the air spring 322 or exhaust air pressure from the air spring 322 through an exhaust outlet 346. In some embodiments, the predetermined nominal ride height comprises a range of acceptable ride heights, such as a nominal ride height plus or minus a tolerance, for example and without limitation ±0.25 inches. Some examples of suitable air springs with non-contact height sensors are further described in U.S. Pat. No. 9,694,640, filed Apr. 9, 2014, entitled NON-CONTACT POWER SUPPLY FOR HEIGHT SENSOR WITH SINGLE CABLE, the disclosure of which is incorporated herein by reference in its entirety.

This system offers a number of advantages. For example, the height sensor 323 is located inside the air spring 322 and thus is protected from the weather, dirt, and other contaminants. The pneumatic control valves 326 can also be positioned so that they are not exposed to contamination or weather. The system is micro-computer controlled and so the responsiveness of the system and the control algorithm used to determine the roll control of the vehicle can be easily adjusted through software changes.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments. Accordingly, the embodiments are not limited except as by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

What is claimed is:

1. A pneumatic anti-roll system for use on a vehicle suspension having left and right side air springs, the system comprising:
left and right side height control valves mountable to a chassis of the vehicle;
left and right side linkages connectable between the left and right side height control valves and corresponding left and right end portions of an axle of the vehicle suspension; and
left and right side control air lines connectable between the left and right side height control valves and corresponding left and right side air springs, respectively.

2. The pneumatic anti-roll system of claim 1, further comprising an air tank pneumatically connected to the left and right side height control valves.

3. The pneumatic anti-roll system of claim 1, wherein the left side control valve is connectable to a pair of left side air springs and the right side control valve is connectable to a pair of right side air springs.

4. The pneumatic anti-roll system of claim 1, wherein the left and right side height control valves include corresponding left and right side valve arms, and wherein the left and right side linkages are configured to move the left and right side valve arms toward an inflate position or an exhaust position in response to movement of the left and right end portions of the axle.

5. The pneumatic anti-roll system of claim 1, wherein the left and right side valve arms move toward the inflate position as the corresponding left and right side end portions of the axle move upward toward the chassis.

6. A pneumatic anti-roll system for use on a vehicle suspension, the system comprising:
left and right side air springs connectable between a chassis of the vehicle and an axle of the vehicle suspension;
left and right side height control valves mountable to the chassis;
left and right side linkages connectable between the left and right side height control valves and corresponding left and right end portions of the axle; and
left and right side control air lines connectable between the left and right side height control valves and corresponding left and right side air springs, respectively.

7. The pneumatic anti-roll system of claim 6, further comprising an air tank pneumatically connected to the left and right side height control valves.

8. The pneumatic anti-roll system of claim 6, wherein the left side control valve is connectable to a pair of left side air springs and the right side control valve is connectable to a pair of right side air springs.

9. The pneumatic anti-roll system of claim 6, wherein the left and right side height control valves include corresponding left and right side valve arms, and wherein the left and right side linkages are configured to move the left and right side valve arms toward an inflate position or an exhaust position in response to movement of the left and right end portions of the axle.

10. The pneumatic anti-roll system of claim 6, wherein the left and right side valve arms move toward the inflate position as the corresponding left and right side end portions of the axle move upward toward the chassis.

11. A pneumatic anti-roll system for use on a vehicle suspension, the system comprising:
left and right side air springs connectable between a chassis of the vehicle and an axle of the vehicle suspension;
left and right side height sensors positioned in respective ones of the left and right side air springs;
left and right side electronically controlled valves mountable to the chassis;
left and right side control air lines connectable between the left and right side electronically controlled valves and corresponding left and right side air springs, respectively; and
a controller electrically coupled to the left and right side electronically controlled valves and the left and right side height sensors.

12. A pneumatic anti-roll system of claim 11, wherein the controller includes instructions for:
receiving signals from the left and right side height sensors corresponding to a left side ride height and a right side ride height;
operating the left side electronically controlled valve to inflate the left side air spring when the left side ride height is less than a predetermined ride height range; and
operating the right side electronically controlled valve to inflate the right side air spring when the right side ride height is less than the predetermined ride height range.

13. The pneumatic anti-roll system of claim 12, wherein the controller includes instructions for:
operating the left side electronically controlled valve to exhaust the left side air spring when the left side ride height is greater than the predetermined ride height range; and
operating the right side electronically controlled valve to exhaust the right side air spring when the right side ride height is greater than the predetermined ride height range.

14. The pneumatic anti-roll system of claim 11, wherein the left and right side air springs comprise a pair of left side air springs and a pair of right side air springs.

15. The pneumatic anti-roll system of claim 11, further comprising an air tank pneumatically connected to the left and right side electronically controlled valves.
